(19) United States
(12) Patent Application Publication
(10) Pub. No.: US 2008/0292847 A1
(43) Pub. Date: Nov. 27, 2008

(54) VIEW PANEL, METHOD FOR MAKING THE VIEW PANEL, AND ELECTRONIC DEVICE USING THE VIEW PANEL

(75) Inventors: CHE-YUAN HSU, Shindian (TW); KEN-HOLM HANSEN, Faarevejle (DK)

Correspondence Address: PCE INDUSTRY, INC.;ATT. CHENG-JU CHIANG, 458 E. LAMBERT ROAD, FULLERTON, CA, 92835, US

(73) Assignee: Sutech Trading Limited, Tortola (VG)

(21) Appl. No.: 11/946,313

(22) Filed: Nov. 28, 2007

(30) Foreign Application Priority Data
May 25, 2007 (CN) 200710074587.0

(51) Int. Cl. B32B 3/14; B05D 1/36

(52) U.S. Cl. 428/172; 427/265; 428/201; 428/412

(57) ABSTRACT

A view panel (10) for an electronic device includes a substrate (11) and a paint layer (12). The substrate is made of a transparent material. The paint layer is formed on one surface of the view panel. The painting coating includes at least two paint coatings. Each of the at least two paint coatings is partially interlaced with another one of the at least two paint coatings. A method for making the view panel and an electronic device (100) using the view panel are also provided. The electronic device includes a housing (30), a display unit (20) and the view panel.

### BACKGROUND OF THE INVENTION

1. Field of the Invention

The present invention generally relates to view panels, particularly, to a color view panel, and an electronic device using the same.

2. Description of Related Art

A typical mobile electronic device has a display system for displaying digital information, images, or graphs. The display system includes a display element and a view panel. The view panel covers the display element to protect the display element from being damaged. The view panel is usually made of a transparent material, such as resin or glass. When the display element is actuated, light can be transmitted through the view panel into eyes of users. However, typical view panels are colorless, thus colorful appearance of the view panels cannot be obtained.

Therefore, a color view panel for an electronic device is desired, in order to overcome the above-described shortcomings.

### SUMMARY OF THE INVENTION

In one embodiment thereof, a view panel of an electronic device is provided. The view panel includes a substrate and a paint layer. The substrate is made of a transparent material. The paint layer is formed on one surface of the view panel. The painting coating includes at least two paint coatings. Each of the at least two paint coatings is partially interlaced with another one of the at least two paint coatings.

Other advantages and novel features will become more apparent from the following detailed description of preferred embodiments when taken in conjunction with the accompanying drawings.

### BRIEF DESCRIPTION OF THE DRAWINGS

Many aspects of the view panel can be better understood with reference to the following drawing. The components in the drawing are not necessarily drawn to scale, the emphasis instead being placed upon clearly illustrating the principles of the view panel. Moreover, in the drawing like reference numerals designate corresponding parts throughout the several views.

FIG. 1 is a perspective view of an electronic device using a view panel in accordance with a present embodiment;

FIG. 2 is a cross-sectional view of the view panel in FIG. 1;

FIG. 3 is a perspective view of a first surface of the view panel in FIG. 2;

FIG. 4 is a perspective view of a second surface of the view panel in FIG. 2; and

FIG. 5 is a schematic view of an operation state of forming a paint layer using a first spray gun and a second spray gun in accordance with a present embodiment.

### DETAILED DESCRIPTION OF THE INVENTION

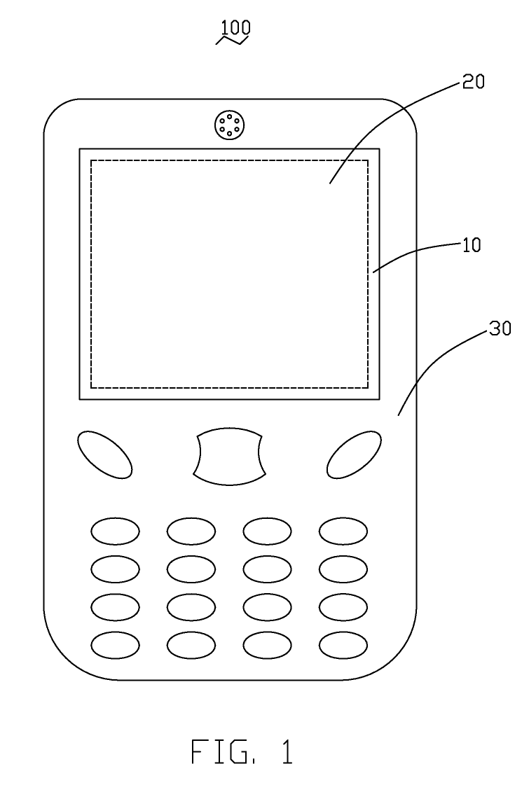

Referring to FIG. 1, in a present embodiment, an electronic device 100 includes a view panel 10, a display unit 20 installed under the view panel 10, and a housing 30 for receiving and fixing the view panel 10 and the display unit 20 therein. The view panel 10 is embedded into the housing and covers the display unit 20. Light transmitted from the display unit 20 may pass through the view panel 10 and enter into eyes of users.

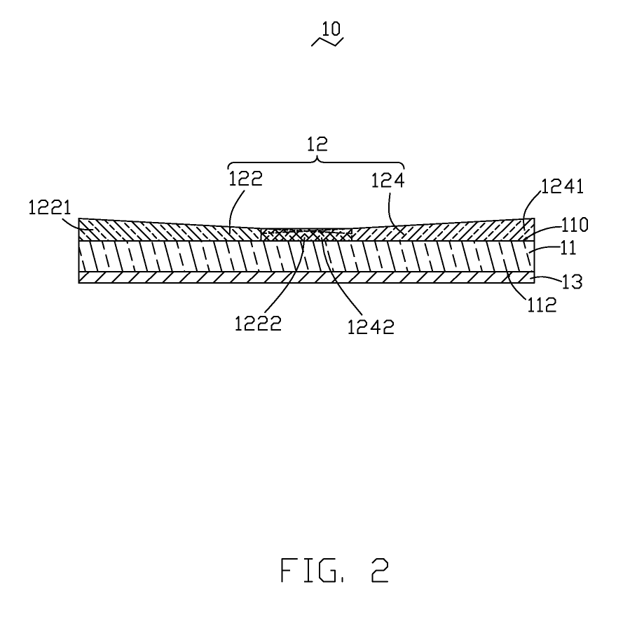

Referring to FIG. 2, the view panel 10 includes a substrate 11, a paint layer 12 mounted on the substrate 11, and a metal coating 13 attached to an opposite side of the substrate 11, i.e., the substrate 11 is sandwiched between the paint layer 12 and the metal coating 13. The view panel 10 may have a light transmission rate in an approximate range of 10% to 50% during the visible wavelength region.

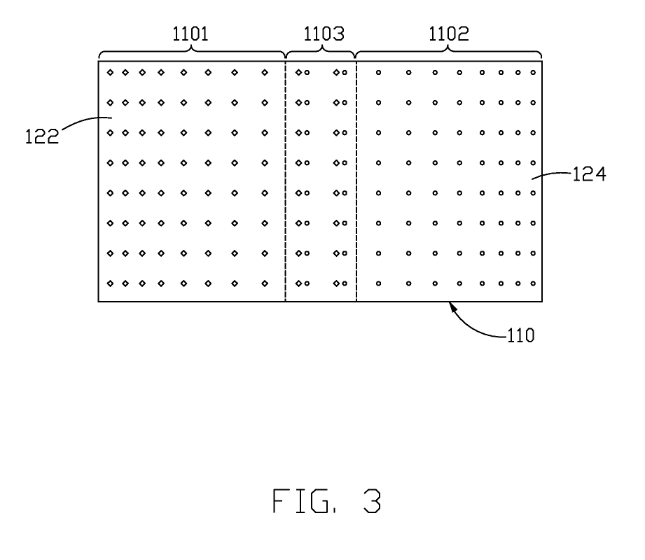

The substrate 11 is made of a transparent material, such as an optical plastic or glass. The substrate 11 is preferably made of polycarbonate resin. The substrate 11 has a first surface 110 and a second surface 112 at an opposite side of the first surface 110. Referring to FIG. 3, the first surface 110 includes a first section 1101, a second section 1102, and a joint section 1103 connected between the first section 1101 and the second section 1102.

Also referring to FIG. 2 and FIG. 3, the paint layer 12 includes at least two coats of transmissive paints. Each coat of the paints has a respective color. The paint layer 12, for example, includes a first paint coating 122 and a second paint coating 124. The first paint coating 122 may be made of a red paint. The second paint coating 124 may be made of a yellow paint. The first paint coating 122 has a first outer end 1221 and a first inner end 1222 at an opposite side of the first outer end 1221. The second paint coating 124 has a second outer end 1241 and a second inner end 1242 at an opposite side of the second outer end 1241. The thickness of the first paint coating 122 decreases from the first outer end 1221 thereof to the first inner end 1222 thereof. The thickness of the second paint coating 124 decreases from the second outer end 1241 thereof to the second inner end 1242 thereof. The first paint coating 122 is formed on the first section 1101 and the joint section 1103, with the first inner end 1222 thereof being formed on the joint section 1103. The second paint coating 124 is formed on the second section 1102 and the joint section 1103, with the second inner end 1242 thereof being formed on the joint section 1103. That is, the first paint coating 122 and the second paint coating 124 are partially interlaced with each other on the joint section 1103. As such, a smooth transition between the first paint coating 122 and the second paint coating 124 can be achieved.

It should be understood, that each of the first paint coating 122 and the second paint coating 124 can be a discontinuous film, which has a thickness in an approximate range from 0.01 μm to 10 μm.

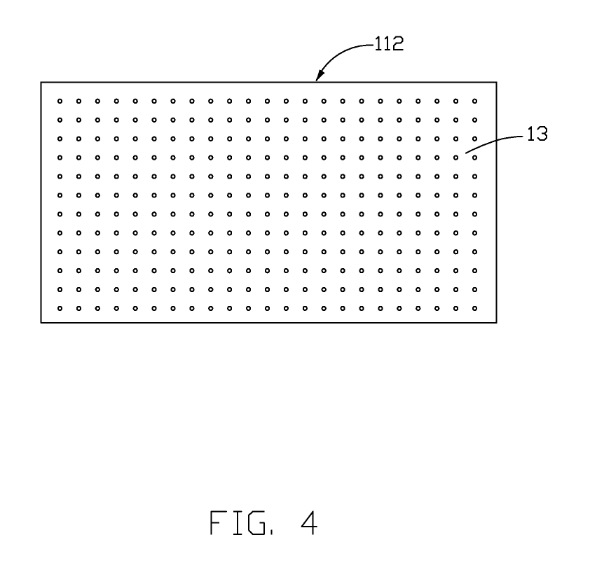

Referring to FIG. 4, the metal coating 13 is formed on the second surface 112 via physical vapor deposition. The metal coating 13 can be made from the following metal material, tin, aluminum, copper, steel, or any combination thereof. The metal coating 13 is, advantageously, made of tin so as to reduce an opportunity of electromagnetic interference. The metal coating 13 should advantageously, be a discontinuous thin film with a thickness less than 10 μm of which particles are arranged as island-like distribution. The metal coating may have a light transmission rate of more than 15% during the visible wavelength region.

The display unit 20 may be a liquid crystal display unit or a light emitting diode display unit.

The housing 30 may be made of plastic. The housing 30 may be moldingly attached with the view panel 10 with colorful appearance similar to the view panel 10.

It should be understood that the view panel 10 could, advantageously, be a non-interface portion of the housing 30 and made of an optical plastic the same as that of the housing 30.

It should be understood that a transparent protective coating could be employed onto the first paint coating 122 and the second paint coating 124 so as to protect the first paint coating 122 and the second paint coating 124 from being damaged. The protective coating could be a resin coating, such as polycarbonate coating.

When the display unit 20 is actuated, the display unit 20 transmits light thereby displaying images, graphs, and/or characters. The light transmitted from the display unit 20 is partially reflected and partially refracted by paint particles of the view panel 10, thus gorgeous and colorful appearance of the view panel 10 can be obtained. When the display unit 20 is non-operative, light of the environment entered into the display unit 20 may be substantially absorbed. Thus the view panel 10 has colorful appearance similar to the housing 30, and the view panel 10 and the housing 30 can be seen as an integrated body.

An exemplary method for making the view panel 10 is provided. In a first step of the method, the substrate 11 is provided.

In a second step of the method, the metal coating 13 is formed onto the second surface 112 via physical vapor deposition.

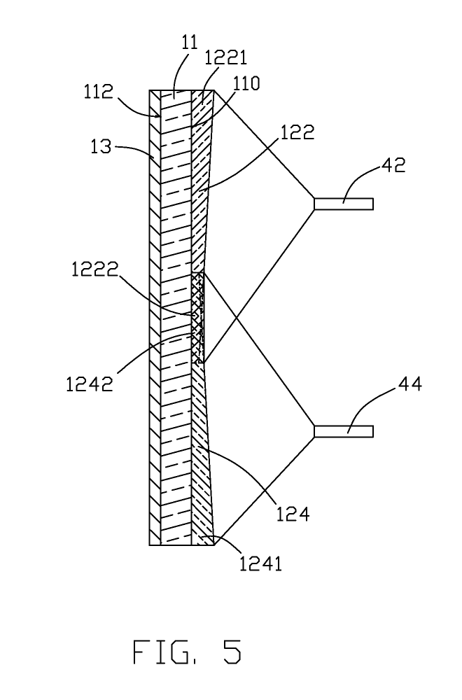

Referring to FIG. 5, in a third step of the method, a first spray gun 42 is provided. A first paint with a red color is sprayed onto the first section 1101 and the joint section 1103 to form the first paint coating 122 by using the first spray gun 42. Also referring to FIG. 3, the thickness of the first paint coating 122 decreases from the first outer end 1221 thereof to the first inner end 1222 thereof. For the purpose of obtaining the first paint coating 122 with the above described character related to the thickness thereof, during the spraying process, the first spray gun 42 is moved from a first position near an outer end of the first section 1101 to a second position near the joint section 1103, as a spray rate of the first paint decreases and/or the perpendicular distance increases between the first spray gun 42 to the substrate 11.

In a fourth step of the method, a second spray gun 44 is provided. A second paint with a yellow color is sprayed onto the second section 1102 and the joint section 1103 to form the second paint coating 124 by using the second spray gun 44. Also referring to FIG. 3, the thickness of the second paint coating 124 decreases from the second outer end 1241 thereof to the second inner end 1242 thereof. For the purpose of obtaining the second paint coating 124 with the above described character related to the thickness thereof, during the spraying process, the second spray gun 44 is moved from a third position near an outer end of the second section 1102 to a fourth position near the joint section 1103, as a spray rate of the second paint decreases and/or the perpendicular distance increases between the second spray gun 44 and the substrate 11.

As such, a smooth transition between the first paint coating 122 and the second paint coating 124 can be achieved. It should be understood, however, that the third step and the fourth step should also be performed at the same time.

It should be understood that a fifth step could be employed to form a transparent protective coating onto the first paint coating 122 and the second paint coating 124. The protective coating could be a resin coating, such as polycarbonate coating.

It should be understood, however, that more than two paint coatings could be employed to substrate. Every two neighboring paint coatings are partially interlaced. Every two neighboring paint coatings have a joint reign with smooth color transition.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A view panel for an electronic device, comprising:
a substrate made of a transparent material; and
a paint layer formed on one surface of the view panel, the painting coating being comprised of at least two transmissive paint coatings, each of the at least two paint coatings is partially interlaced with another one of the at least two paint coatings.

2. The view panel as claimed in claim 1, wherein the substrate is made of polycarbonate resin.

3. The view panel as claimed in claim 1, wherein each of the at least two paint coatings has a thickness decreasing from a first end thereof to an second end thereof at an opposite side of the first end, the at least two paint coatings being partially interlaced with each other at the second end thereof.

4. The view panel as claimed in claim 1, wherein each of the at least two paint coatings is a discontinuous film, which has a thickness in an approximate range from 0.01 μm to 10 μm.

5. The view panel as claimed in claim 1, further comprising a metal coating formed on a surface of the substrate at an opposite side of the paint layer.

6. The view panel as claimed in claim 5, wherein the metal coating is made of tin, with a light transmission rate more than 15% during the visible wavelength region.

7. The view panel as claimed in claim 5, wherein the metal coating is a discontinuous thin film with a thickness less than 10 μm, particles of the metal coating being arranged as island-like distribution.

8. The view panel as claimed in claim 5, wherein the view panel has a light transmission rate in an approximate range from 10% to 50% during the visible wavelength region.

9. A method for making a view panel, comprising the steps of:
providing a substrate made of a transparent material, the substrate having a first surface comprising a first section, a second section, and a joint section connected between the first section and the second section;
applying a first paint onto the first section of the substrate and the joint section of the substrate; and
applying a second paint onto the second section of the substrate and the joint section of the substrate, with the first paint and the second paint being partially interlaced onto the joint section of the substrate.

10. The method as claimed in claim 9, wherein the step of applying the first paint onto the first section and the joint section is carried out via spraying the first paint onto the first section and the joint section using a first spray gun, the first spray gun being configured to move from a first position near an outer end of the first section to a second position near the joint section, as a spray rate of the first paint decreases and/or the perpendicular distance between the first spray gun and the substrate increases.

11. The method as claimed in claim 9, wherein the step of applying the second paint onto the first section and the joint section is carried out via spraying a second paint onto the second section and the joint section using a second spray gun, the second spray gun being configured to move from a third position near an outer end of the second section to a fourth position near the joint section, as the spray rate of the second paint decreases and/or the perpendicular distance between the second spray gun to the substrate increases.

12. The method as claimed in claim 9, further comprising applying a metal coating made of tin onto a second surface of the substrate at an opposite side of the first surface, the metal coating having a light transmission rate more than 15% during the visible wavelength region.

13. The method as claimed in claim 9, the metal coating is a discontinuous thin film with a thickness less than 10 μm, particles of the metal coating being arranged as island-like distribution.

14. An electronic device, comprising:
a housing;
a display unit received in the housing; and
a view panel being embedded into the housing and covering the display unit, the view panel comprising:
a substrate made of a transparent material; and
a paint layer formed on one surface of the view panel, the paint layer being comprised of at least two light transmissive paint coatings, each of the at least two paint coatings is partially interlaced with another one of the at least two paint coatings.

15. The electronic device as claimed in claim 14, wherein the substrate is made of polycarbonate resin.

16. The electronic device as claimed in claim 14, wherein each of the at least two paint coatings has a thickness decreasing from a first end thereof to an second end thereof at an opposite side of the first end, the at least two paint coatings being partially interlaced with each other at the second end thereof.

17. The electronic device as claimed in claim 14, wherein each of the at least two paint coatings is a discontinuous film, which has a thickness in an approximate range from 0.01 μm to 10 μm.

18. The electronic device as claimed in claim 14, further comprising a metal coating formed on a surface of the substrate at an opposite side of the paint layer, the metal coating having a light transmission rate more than 15% during the visible wavelength region.

19. The electronic device as claimed in claim 18, the metal coating is a discontinuous thin film made of tin, with a thickness less than 10 μm, particles of the metal coating being arranged as island-like distribution.

20. The electronic device as claimed in claim 14, wherein the view panel has a light transmission rate in an approximate range from 10% to 50% during the visible wavelength region.
